(19) United States
(12) Patent Application Publication
(10) Pub. No.: US 2002/0186164 A1
(43) Pub. Date: Dec. 12, 2002

(54) Searching apparatus

(76) Inventors: William Hsu, Chu Pei City (TW); Oliver Huang, Hsinchu (TW); Vincent Hung, Hsinchu (TW); Neil Yang, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/876,025

(22) Filed: Jun. 8, 2001

(51) Int. Cl. G01S 5/14

(52) U.S. Cl. 342/357.09

(57) ABSTRACT

A searching apparatus comprises a searched object, a GPS transceiver and a communication unit. The GPS transceiver is arranged within the searched object and has an initializing circuit providing an enabling signal after receiving a control signal from the communication unit, a GPS receiver determining the position of the searched object when it is enabled by the initializing circuit, and an audio modulator converting the position data of the searched object into audio signal. The communication unit receives the audio signal and converts the audio signal to digital signal. The digital signal is displayed on monitor of computer or LCD panel to show the position of the searched object.

### FIELD OF THE INVENTION

The present invention relates to a searching apparatus, especially to a searching apparatus employing audio signal for conveying searching reply.

### BACKGROUND OF THE INVENTION

The global positioning system (GPS) is an apparatus to find the position thereof by detecting the signal from positioning satellites. The GPS can be used to find the place of searched objects such as vehicles or outgoing child. As shown in FIG. 1, the searching system generally involves a console 70 to command at least one base station 60 for finding the position of the searched object 1. The console 70 increases the cost and complexity of the searching system.

### SUMMARY OF THE INVENTION

It is the object of the present invention to provide a searching apparatus employing audio signal for conveying searching reply and does not involve a console.

In one aspect of the invention, the GPS transceiver is arranged within the searched object and has an initializing circuit providing an enabling signal after receiving a control signal from the communication unit, a GPS receiver determining the position of the searched object when it is enabled by the initializing circuit, and an audio modulator converting the position data of the searched object into audio signal. The communication unit receives the audio signal with the help of the wireless communication device (mobile phone, walki-talki, or ISM-band radio) and converts the audio signal to digital signal. The digital signal is displayed on monitor of computer or LCD panel to show the position of the searched object.

In another aspect of the invention, the searching apparatus employs audio signal for conveying searching reply and does not involve a console, the cost is reduced.

The various objects and advantages of the present invention will be more readily understood from the following detailed description when read in conjunction with the appended drawing, in which:

### BRIEF DESCRIPTION OF DRAWINGS

FIG. 1 shows the schematic view of prior art searching apparatus;

FIG. 2 shows the schematic view of the searching apparatus of the present invention;

FIG. 2A shows the partially enlarged view of FIG. 2;

FIG. 3 shows the block diagram of the GPS transceiver of the present invention;

FIG. 4 shows the block diagram of the communication unit of the present invention;

FIG. 5 shows the first preferred embodiment of the present invention;

FIG. 6 shows the second preferred embodiment of the present invention;

FIG. 7 shows the third preferred embodiment of the present invention.

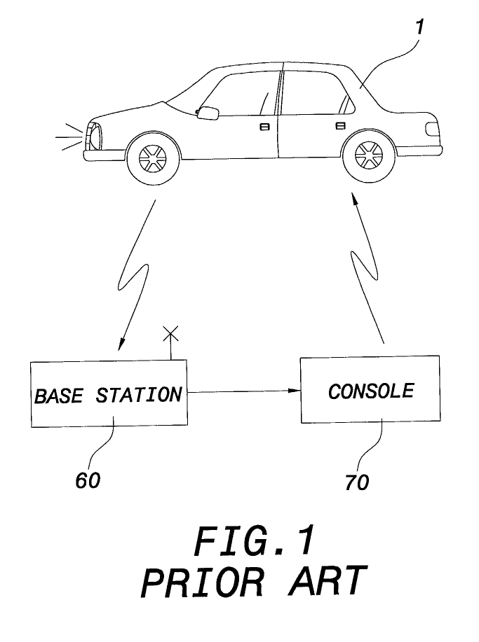

### DETAILED DESCRIPTION OF THE INVENTION

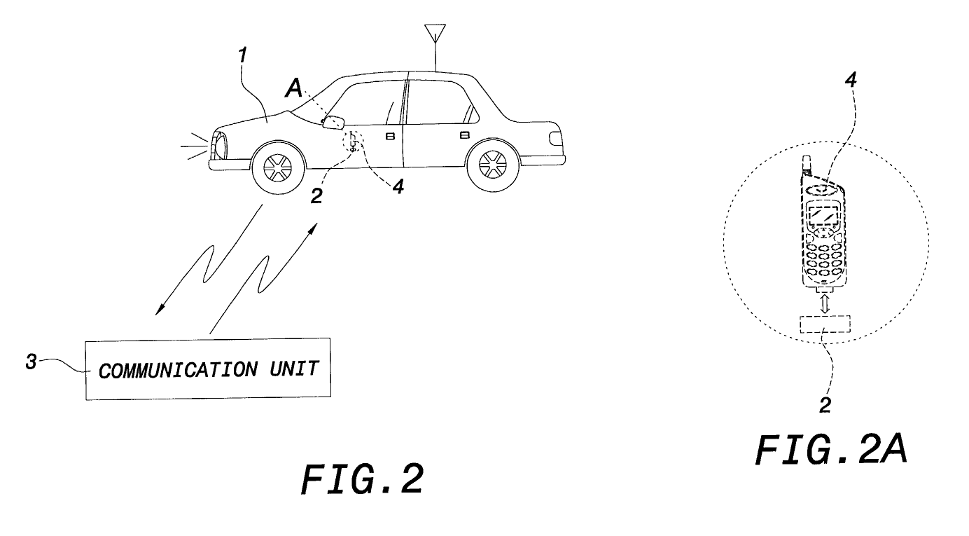

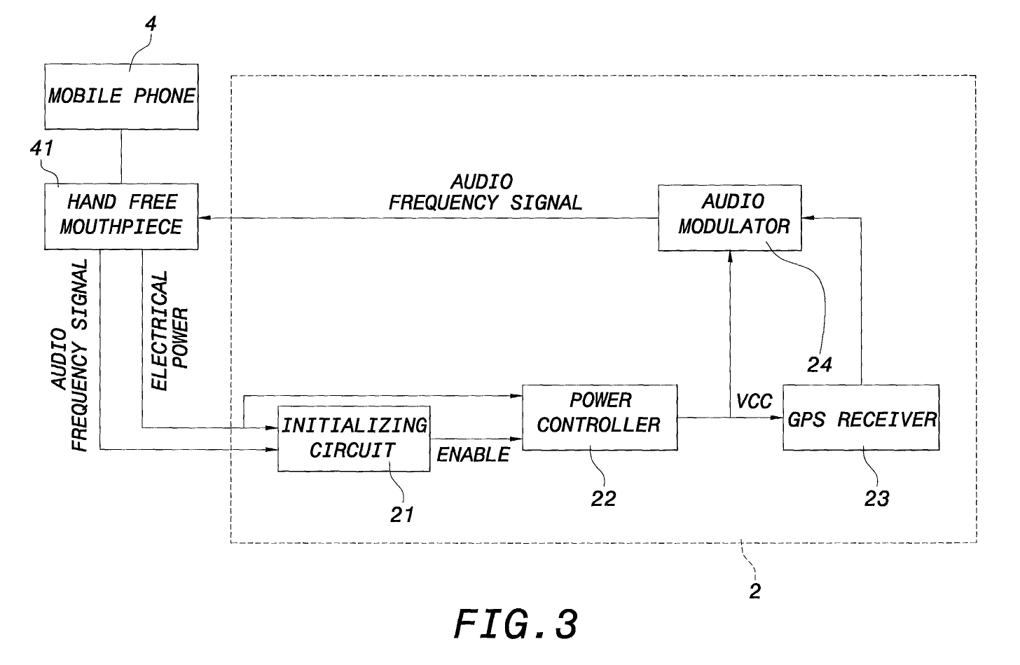

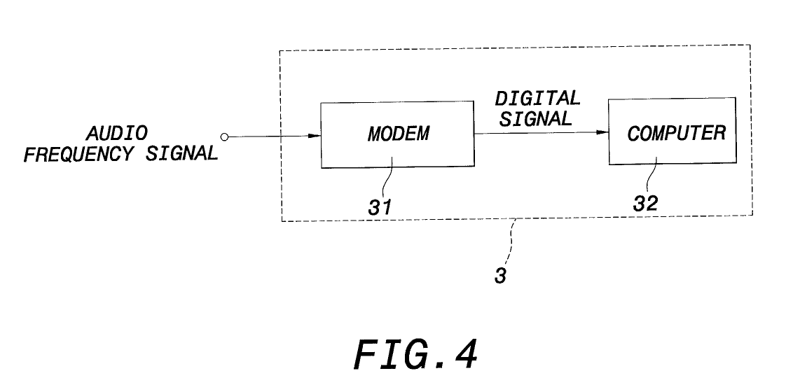

With reference to FIGS. 2 to 4, the present invention is intended to provide a searching apparatus, which comprises a searched object 1, a GPS transceiver 2 and a communication unit 3.

The GPS transceiver 2 is arranged within the searched object 1 and is connected to the electric power and audio signal connector of a hand free mouthpiece 41 of a mobile phone 4. The GPS transceiver 2 receives command from the communication unit 3 and determines the position of the searched object 1. The position of the searched object 1 is modulated to an audio signal.

The GPS transceiver 2 is composed of an initializing circuit 21, a power controller 22, a GPS receiver 23 and an audio modulator 24. The initializing circuit 21 has an input connected to the electric power and audio signal connector of the hand free mouthpiece 41 of the mobile phone 4. The initializing circuit 21 receives command from the communication unit 3 and generates a corresponding enabling signal.

The power controller 22 is connected to an output of the initializing circuit 21 and output the electrical power received by the initializing circuit 21 when it is enabled by the initializing circuit 21.

The GPS receiver 23 is connected to an output of the power controller 22 and determines the position of the searched object 1 when it is enabled by the initializing circuit 21.

The audio modulator 24 is connected to output of the power controller 22 and the GPS receiver 23. The audio modulator 24 has an output connected to the audio signal connector of the hand free mouthpiece 41. The audio modulator 24 is controlled by the GPS receiver 23 and converts the position data of the searched object 1 into audio signal and sends the audio signal through the mobile phone 4.

The communication unit 3 is used to convert the audio signal sent by the mobile phone 4 into a digital signal and display the position data contained in the digital signal to a computer monitor (or a LCD panel), or transmits the position data contained in the digital signal to other devices.

The communication unit 3 is composed of a modem 31 and a computer 32. The modem 31 is used to convert the audio signal sent by the mobile phone 4 into a digital signal and send the digital signal to the computer 32. The position data contained in the digital signal is displayed on the monitor of the computer 32.

When the user of the communication unit 3 wants to know the position of the searched object 1. The communication unit 3 provides a control signal to the GPS transceiver 2. The initializing circuit 21 enables the power controller 22 to determine the position data of the searched object 1, when the initializing circuit 21 receives the control signal from the communication unit 3. The position data of the searched object 1 is sent to the audio modulator 24, which is controlled by the GPS receiver 23 and converts the position data of the searched object 1 into audio signal. The audio signal is sent, through the mobile phone 4, to the modem 31 of the communication unit 3. The modem 31 converts the audio signal sent by the mobile phone 4 into a digital signal and sends the digital signal to the computer 32. The position data contained in the digital signal is displayed on the monitor of the computer 32.

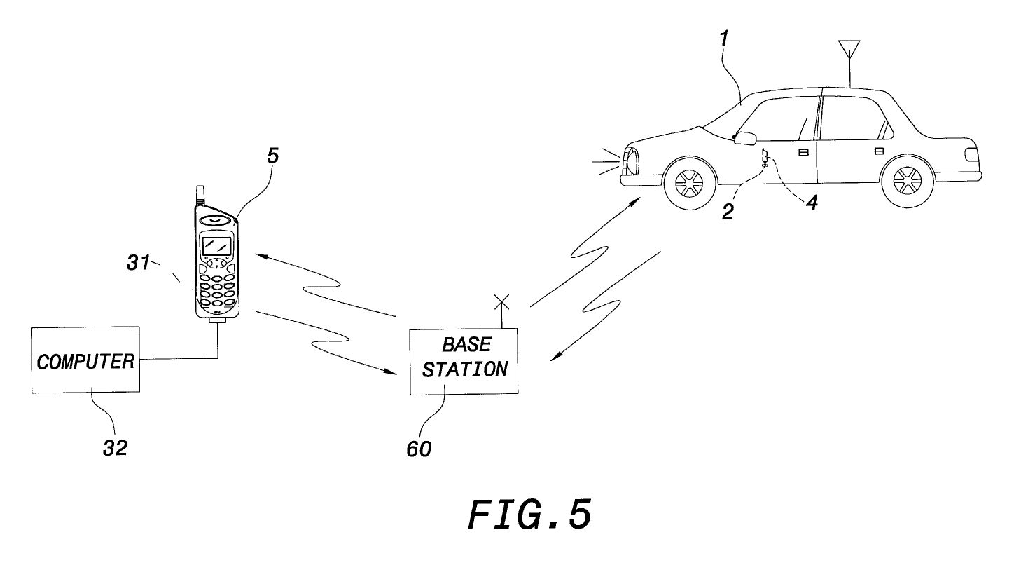

As shown in FIG. 5, the modem 31 can be arranged within a mobile phone 5 and the mobile phone 5 is connected to the computer 32 through a connection port thereof.

When the user of the communication unit 3 wants to know the position of the searched object 1. The communication unit 3 provides an audio signal to the GPS transceiver 2 through the base station 60. The initializing circuit 21 enables the power controller 22 to determine the position data of the searched object 1, when the initializing circuit 21 receives the audio signal from the communication unit 3. The position data of the searched object 1 is sent to the audio modulator 24, which is controlled by the GPS receiver 23 and converts the position data of the searched object 1 into audio signal. The audio signal is sent, through a mobile communication device (not shown), to the modem 31 of the communication unit 3. The modem 31 converts the audio signal sent by the mobile phone 4 into a digital signal and sends the digital signal to the computer 32. The position data contained in the digital signal is displayed on the monitor of the computer 32.

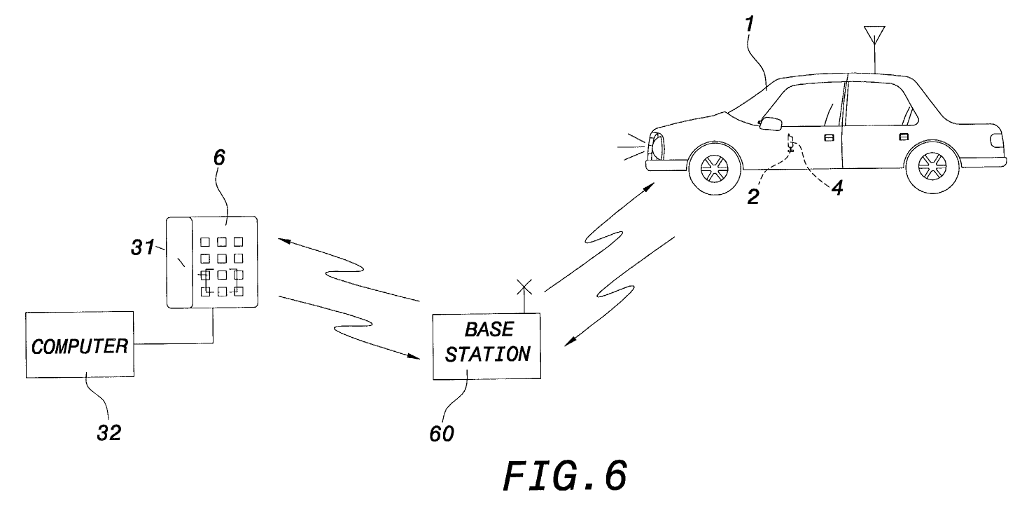

As shown in FIG. 6, the modem 31 can be arranged within a household telephone 6 and the household telephone 6 is connected to the computer 32 through a connection port thereof. The household telephone 6 receives audio signal containing the position data and displays the position of the searched object 1 on the monitor of the computer 32 or a LCD panel.

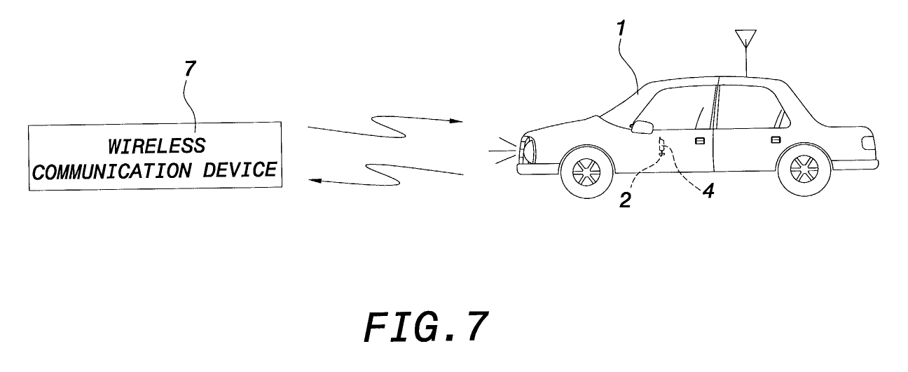

As shown in FIG. 7, the modem 31 can be arranged within a wireless communication device 7 and the wireless communication device 7 is connected to the computer 32 through a connection port thereof. The wireless communication device 7 receives audio signal containing the position data and displays the position of the searched object 1 on the monitor of the computer 32 or a LCD panel.

To sum up, the searching apparatus of the present invention has following advantages:

(1) The searching apparatus is not restricted by

(2) The searching apparatus uses audio signal as transmission medium.

(3) The searching apparatus enhances convenience.

(4) The cost is reduced.

Although the present invention has been described with reference to the preferred embodiment thereof, it will be understood that the invention is not limited to the details thereof. Various substitutions and modifications have suggested in the foregoing description, and other will occur to those of ordinary skill in the art. For example, the initializing circuit can be powered by battery or external device. The wireless communication device can be mobile phone, walki-talki, ISM-band radio etc. Therefore, all such substitutions and modifications are intended to be embraced within the scope of the invention as defined in the appended claims.

I claim:

1. A searching apparatus, comprising:
a searched object;
a GPS transceiver arranged within the searched object and receiving an external signal to receive electrical power from an external source and determine a position data of the searched object; the GPS transceiver modulating the position data to an audio signal;
a wireless communication unit receiving the audio signal from the GPS transceiver and transmitting the audio signal; and
a communication unit receiving the audio signal from the wireless communication unit and converting the audio signal to a digital signal containing the position data of the searched object.

2. The searching apparatus as in claim 1, wherein the GPS transceiver comprises:
an initializing circuit receiving the external signal and sending an enabling signal;
a power controller connected to the initializing circuit and outputting an electrical power received by the initializing circuit when it is enabled by the initializing circuit;
a GPS receiver connected to an output of the power controller and determining the position of the searched object when it is enabled by the initializing circuit; and
an audio modulator connected to output of the power controller and the GPS receiver, and converting the position data of the searched object into audio signal.

3. The searching apparatus as in claim 1, wherein the electrical power sent to the GPS transceiver is from battery.

4. The searching apparatus as in claim 1, wherein the electrical power sent to the GPS transceiver is from a hand free mouthpiece of a mobile phone.

5. The searching apparatus as in claim 1, wherein the wireless communication device is mobile phone, walki-talki, ISM-band radio.

6. The searching apparatus as in claim 1, wherein the communication unit is composed of
a modem converting the received audio signal into a digital signal; and
a computer connected to the modem and displaying the position of the searched object on a monitor thereof according to the digital signal.

7. The searching apparatus as in claim 1, wherein the communication unit is composed of
a modem converting the received audio signal into a digital signal; and
a display connected to the modem and displaying the position of the searched object according to the digital signal.

8. The searching apparatus as in claim 6 or 7, wherein the modem is arranged within a mobile phone, a household telephone or a wireless communication unit.
